(19) United States
(12) Patent Application Publication
(10) Pub. No.: US 2004/0208529 A1
(43) Pub. Date: Oct. 21, 2004

(54) Method of packet corruption to halt propagation in an optical wireless link

(76) Inventors: James E. Noxon, Rochester, MN (US); Karl K. Northrup, Rochester, MN (US); Grant S. Christiansen, Rochester, MN (US)

Correspondence Address: TEXAS INSTRUMENTS INCORPORATED, P O BOX 655474, M/S 3999, DALLAS, TX, 75265

(21) Appl. No.: 10/145,974

(22) Filed: May 14, 2002

(51) Int. Cl. H04B 10/00

(52) U.S. Cl. 398/33

(57) ABSTRACT

A method of implementing packet corruption to halt propagation in an optical wireless communication link in a manner that simultaneously minimizes network overhead and maintains a high bandwidth loop sufficient to control the motion of the mirror.

### BACKGROUND OF THE INVENTION

1. Field of the Invention

This invention relates generally to optical wireless communication links, and more particularly, to a method of packet corruption to halt propagation in an optical wireless link.

2. Description of the Prior Art

An optical wireless link system consists of two stations or optical wireless links (OWLs): Each of which contains an optical transmitter and an optical receiver. The transmitter is able to change the direction of its transmitted beam by known amounts of angular displacement. The receiver sees this motion and sends position correction information back to the transmitter. This feedback is used by a servo control loop to position the transmitted beam on the receiver of the remote station.

Status packets and link control packets associated with the two OWLs can have detrimental effects on the system since they both require processing power; and if implemented as standard protocol packets, can also be transmitted on to the rest of the network, using up bandwidth.

When a packet arrives at the receiver, the receiver has to look at the data contained in the packet, decide if the packet is a servo packet, and if so, pull data out of the packet for control use. This processing uses computational resources of the processor that could be used for other purposes. FIG. 3 is a timing diagram illustrating one embodiment of periodic servo timing, including an exploded view detailing tasks performed during one servo period.

Servo packets can also be passed on to the rest of the network, as stated above. This can be problematic since this increases system overhead by undesirably reducing the available system bandwidth, especially if there are many OWLs operating in the network. Further, control packets from one link may undesirably reach another OWL in another link, and be misinterpreted as data from its linked unit with an unpredictable result.

In view of the foregoing, it would be desirable and advantageous in the optical wireless communication art to provide a technique for processing link control or status packets in an optical wireless communication link in a manner that simultaneously minimizes network overhead and maintains a high bandwidth loop sufficient to control the motion of the mirror.

### SUMMARY OF THE INVENTION

The present invention is directed to a method of implementing packet corruption to halt propagation in an optical wireless communication link in a manner that simultaneously minimizes network overhead and maintains a high bandwidth loop sufficient to control the motion of the mirror.

The data stream is passed through “packet pillaging” hardware which recognizes link control or status packets. If the packet is a regular data packet, the pillager passes the data packet with no modification(s). If however, the packet is recognized as a link control or servo packet, the pillager hardware pulls the control information out of the packet and then corrupts the data as it is passed. This corruption will cause the receiver to reject the packets since, due to the corruption, they are no longer valid packets.

In one aspect of the invention, a method of packet corruption to halt propagation in an optical wireless communication link is implemented in a manner that frees up the resources that would have been needed to process the packet.

In another aspect of the invention, a method of packet corruption to halt propagation in an optical wireless communication link is implemented in a manner that does not flood the network with control packets which have no use outside of the link.

In still another aspect of the invention, a method of packet corruption to halt propagation in an optical wireless communication link is implemented in a manner that permits use of the same data protocol for servo packets and data packets.

According to one embodiment, an optical wireless link (OWL) comprises a packet pillager and a receiver, wherein the packet pillager is operational to extract control data from an incoming communication packet containing servo data, and then corrupt the communication packet data subsequent to the data extraction such that the receiver will reject the communication packet as an invalid packet, and further such that the receiver will process only the extracted servo data.

According to another embodiment, an optical wireless link (OWL) comprises means for extracting control data from an incoming data packet containing servo data, and for corrupting the data packet subsequent to extracting the control data; and means for rejecting the corrupted data packet as an invalid packet, and for processing only the extracted control data.

According to yet another embodiment, an optical wireless link (OWL) comprises a packet pillager configured to extract control data from an incoming data packet containing servo data, and then corrupt the packet data subsequent to the data extraction such that the data packet will be rejected by the OWL as an invalid packet, and further such that the OWL will process only the extracted servo data.

According to still another embodiment, a method of optical wireless communication comprises the steps of providing an optical wireless link (OWL) having a receiver and a packet pillager; extracting control data via the packet pillager from an incoming data packet only if the incoming data packet is a servo packet; and corrupting the incoming data packet subsequent to extracting the control data such that the receiver will reject the incoming data packet as an invalid data packet.

### BRIEF DESCRIPTION OF THE DRAWINGS

Other aspects, features and advantages of the present invention will be readily appreciated, as the invention becomes better understood by reference to the following detailed description when considered in connection with the accompanying drawing figures wherein:

FIG. 1 is a block diagram illustrating a pair of OWLs communicating with one another in which each OWL includes a transmitter, receiver and a processor/controller;

FIG. 2 is a block diagram illustrating one embodiment of a control loop suitable for use in an optical wireless link;

FIG. 3 is a timing diagram illustrating one embodiment of periodic servo timing, including an exploded view detailing tasks performed during one servo period; and

FIG. 4 is a block diagram illustrating a pair of OWLs communicating with one another in which each OWL includes a “packet pillager” according to one embodiment of the present invention.

While the above-identified drawing figures set forth particular embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION OF THE PREFERRED EMBODIMENTS

FIG. 1 is a block diagram illustrating an OWL system 100 having a pair of OWLs 102, 103 communicating with one another in which each OWL includes a transmitter 104, a receiver 106 and a processor 112. The transmitter 104 is able to change the direction of its transmitted beam by known amounts of angular displacement. The receiver 106 sees this motion as a linear displacement, and sends position correction information back to the transmitter 104. This feedback is used by a servo control loop algorithm to position the transmitted beam on the receiver 106 of the remote station.

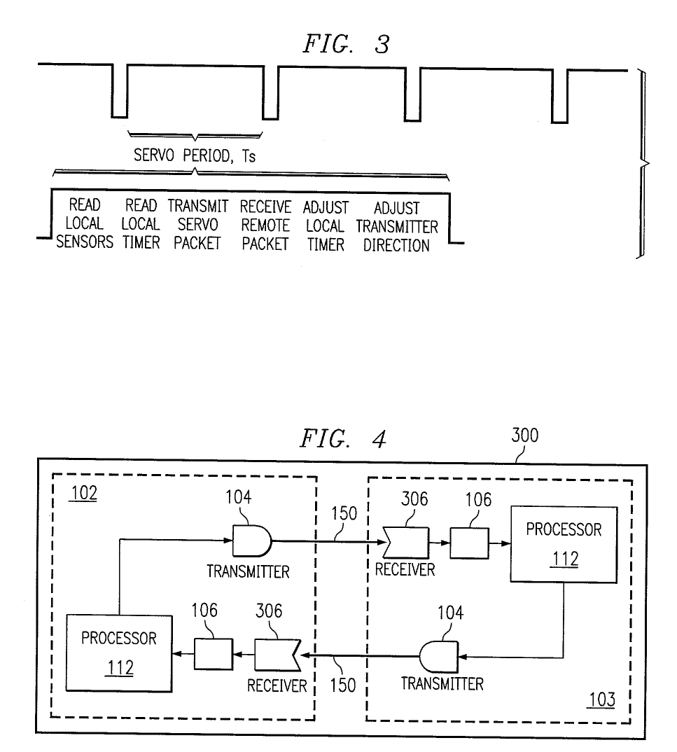

FIG. 3 shows one embodiment of a timing diagram illustrating periodic servo timing, including an exploded view detailing tasks performed during one servo period. U.S. patent application Ser. No. 10/060,549, entitled Calibration Method For Station Orientation, filed by Oettinger et al. on Jan. 30, 2002, discloses a method of calibrating station orientation in an OWL. The '549 patent application is assigned to the assignee of the present invention, and is hereby incorporated by reference in its entirety herein.

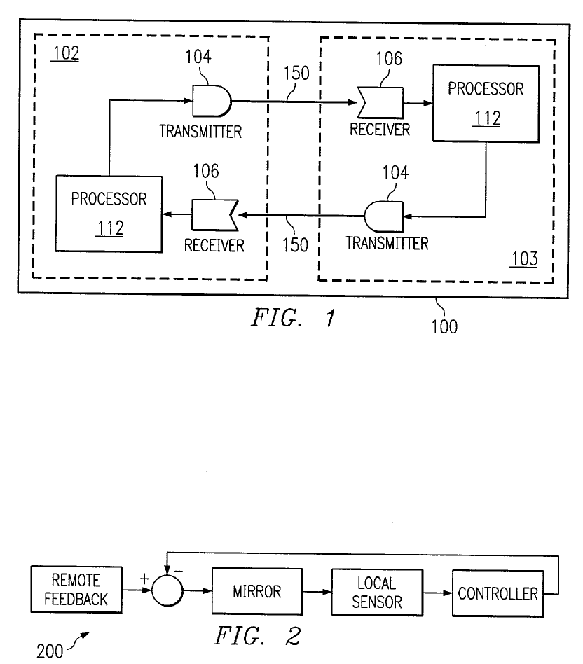

FIG. 2 is a block diagram illustrating one embodiment of a control loop 200 suitable for use in an optical wireless link such as OWL 102, 103 depicted in FIG. 1. Operational details of control loop 200 are set forth in U.S. patent application entitled Method Of Sampling Local And Remote Feedback In An Optical Wireless Link, docket no. TI-33553, filed by Oettinger et al., on Apr. 29, 2002, and which is incorporated by reference in its entirety herein.

FIG. 4 is a block diagram illustrating an OWL system 300 having a pair of OWLs 302, 304 communicating with one another in which each OWL includes a transmitter 104, a receiver 106, a packet pillager 306, and a processor 112. OWL system 300 functions in a similar fashion to OWL system 100 discussed herein before with reference to FIG. 1; wherein the transmitter 104 is able to change the direction of its transmitted beam by known amounts of angular displacement; and the receiver 106 sees this motion as a linear displacement, and sends position correction information back to the transmitter 104. This feedback is likewise used by a servo control loop algorithm to position the transmitted beam on the receiver 106 of the remote station.

OWL system 300 differs from OWL system 100 however, in that OWL system 300 can also be seen to include a “packet pillager” 306. Further structural details regarding packet pillager 306 are not set forth herein to preserve brevity and clarity, and since those skilled in the art of “wireless communication” will be aware of a multiplicity of techniques that can be employed to receive and corrupt a data stream. With continued reference now to FIG. 4, the data stream is passed through hardware (packet pillager 306) that is configured to recognize link packets. If the packet is a regular data packet, the packet pillager 306 simply passes the data packet on to the receiver 106 with no modification. If however, the packet is recognized as a servo packet, then the packet pillager 306 extracts the control information out of the packet and proceeds to corrupt the remaining packet data as it is passed to the receiver 106. This corruption will cause the receiver 106 to reject the packet data, since this packet data will not be recognized as a valid data packet due to the corrupted packet data. This process then frees up the processing resources that would have been necessary to process the remaining packet data, such that this remaining packet data is prevented from flooding the network with control packets which have no use outside of the associated communication link 350.

Those skilled in the art will appreciate that defining a unique transfer protocol for link to link communication could also be implemented to providing similar results. This approach however, would require additional work to transmit packets that are not required with the solution described above with reference to FIG. 4. The method described herein with reference to FIG. 4 advantageously permits use of the identical data protocol for servo packets.

In view of the above, it can be seen the present invention presents a significant advancement in the art of optical wireless communication techniques. Further, this invention has been described in considerable detail in order to provide those skilled in the optical wireless communication art with the information needed to apply the novel principles and to construct and use such specialized components as are required. In view of the foregoing descriptions, it should be apparent that the present invention represents a significant departure from the prior art in construction and operation. However, while particular embodiments of the present invention have been described herein in detail, it is to be understood that various alterations, modifications and substitutions can be made therein without departing in any way from the spirit and scope of the present invention, as defined in the claims which follow.

What is claimed is:

1. An optical wireless link (OWL) comprising:
a packet pillager; and
a receiver, wherein the packet pillager is operational to extract control data from an incoming communication packet containing servo data, and then corrupt the communication packet data subsequent to the data extraction such that the receiver will reject the communication packet as an invalid packet, and further such that the OWL will process only the extracted control data.

2. The OWL according to claim 1, further comprising:
a mirror; and
a control loop operational to position the mirror in response to servo data processed by the receiver.

3. An optical wireless link (OWL) comprising:
means for extracting control data from an incoming data packet containing servo data, and for corrupting the data packet subsequent to extracting the control data; and
means for rejecting the corrupted data packet as an invalid packet, and for processing only the extracted control data.

4. The OWL according to claim 3, further comprising:
a mirror; and
a control loop operational to position the mirror in response to the extracted control data processed by the processing means.

5. The OWL according to claim 3 wherein the means for extracting control data from an incoming data packet containing servo data, and for corrupting the data packet subsequent to extracting the control data comprises a packet pillager.

6. The OWL according to claim 3 wherein the means for rejecting the corrupted data packet as an invalid packet, and for processing only the extracted control data comprises:
an optical receiver; and
a data processor selected from the group consisting of a CPU, a micro-controller, a micro-processor, a micro-computer, a computer, a controller and a digital signal processor.

7. A method of optical wireless communication comprising the steps of:
providing an optical wireless link (OWL) having a receiver and a packet pillager;
extracting control data via the packet pillager from an incoming data packet only if the incoming data packet is a servo packet; and
corrupting the incoming data packet subsequent to extracting the control data such that the receiver will reject the incoming data packet as an invalid data packet.

8. The method of claim 7 further comprising the step of passing the incoming data packet through the packet pillager without extracting control data and without corrupting the incoming data packet whenever the incoming data packet is not a servo packet.

9. An optical wireless link (OWL) comprising a packet pillager configured to extract control data from an incoming data packet containing servo data, and then corrupt the packet data subsequent to the data extraction such that the data packet will be rejected by the OWL as an invalid packet, and further such that the OWL will process only the extracted servo data.

10. The OWL according to claim 9 wherein the packet pillager is further configured to pass the incoming packet data without extracting control data and without corrupting the incoming data packet whenever the incoming data packet is not a servo packet.
